(19) United States
(12) Patent Application Publication
(10) Pub. No.: US 2008/0027725 A1
(43) Pub. Date: Jan. 31, 2008

(54) Automatic Accent Detection With Limited Manually Labeled Data

(75) Inventors: Min Chu, Beijing (CN); Yining Chen, Beijing (CN)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: MICROSOFT CORPORATION, Redmond, WA (US)

(21) Appl. No.: 11/460,028

(22) Filed: Jul. 26, 2006

(51) Int. Cl. G10L 15/18

(52) U.S. Cl. 704/257

(57) ABSTRACT

An accent detection system for automatically labeling accent in a large speech corpus includes a first classifier which analyzes words in the speech corpus and automatically labels accents to provide first accent labels. A second classifier analyzes the words to automatically label accent of the words to provide second accent labels. A comparison engine compares the first and second accent labels. Accent labels that indicate agreement between the first and second classifiers are provided as final accent labels. When there is disagreement between the first and second classifiers, a third classifier analyzes the words and provides the final accent labels.

### BACKGROUND

In text-to-speech (TTS) systems, prosody is very important to make the speech sound natural. Among all prosodic events, accent is probably the most prominent one. In a succession of spoken syllables or words, some will be understood to be more prominent than others. These are accented. To synthesize speech with the correct accent, labeling accent for a large speech corpus is necessary. However, manually annotating the accent labels of a large speech corpus is both tedious and time-consuming. Manually labeling of accent in a large speech corpus typically has to be performed by experts or highly knowledgeable people, and the time requirements of these experts to complete this task are very considerable. This in turn renders manual labeling of accent in a large speech corpus a costly endeavor.

Typically, classifiers used for marking accented/unaccented syllables are trained from manually labeled data only. However, due to the cost of labeling, the quantity of manually labeled data is often not sufficient to train the classifiers with high precision. While automatic labeling of accent in a large speech corpus could help to address this problem, automatic labeling of accent in a speech corpus itself presents other difficulties. For example, automatic labeling of accent is different from other pattern classification problems because very limited training data is typically available to aid in this automation process. Thus, given the limited training data which is typically available, automatic labeling of accent in a large speech corpus can be potentially unreliable.

The discussion above is merely provided for general background information and is not intended to be used as an aid in determining the scope of the claimed subject matter.

### SUMMARY

An accent detection system automatically labels accent in a large speech corpus to reduce the need for manually labeled accent data. The system includes a first classifier, for example a linguistic classifier, which analyzes words in the speech corpus and automatically labels accents to provide first accent labels. The system also includes a second classifier, for example an acoustic classifier, which analyzes the words to automatically label accent to provide second accent labels. A comparison engine compares the first and second accent labels. For accent labels which indicate agreement between the first and second classifiers, these accent labels are provided as final accent labels for the words. When there is disagreement between the first and second classifiers, a third classifier analyzes the words and provides the final accent labels. The third classifier can be a classifier with combined linguistic and acoustic features.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram illustrating one exemplary embodiment of an accent detection system.

FIG. 2 is a block diagram illustrating one more particular accent detection system embodiment.

FIG. 3 illustrates a non-limiting example of a finite state network.

FIG. 4 illustrates one exemplary method embodiment.

FIG. 5 illustrates another exemplary method embodiment.

FIG. 6 illustrates one example of a general computing environment configured to implement disclosed embodiments.

### DETAILED DESCRIPTION

When only a small number of manual accent labels are available, how to take the best advantage of them can be very important in training high performance classifiers, Disclosed embodiments utilize unlabeled data (i.e., data without accent labels) which is more abundant than their labeled counterparts to improve labeling performance. Improving labeling performance without manually labeling a large corpus potentially saves time and cost, while still providing the training data required to train high performance classifiers.

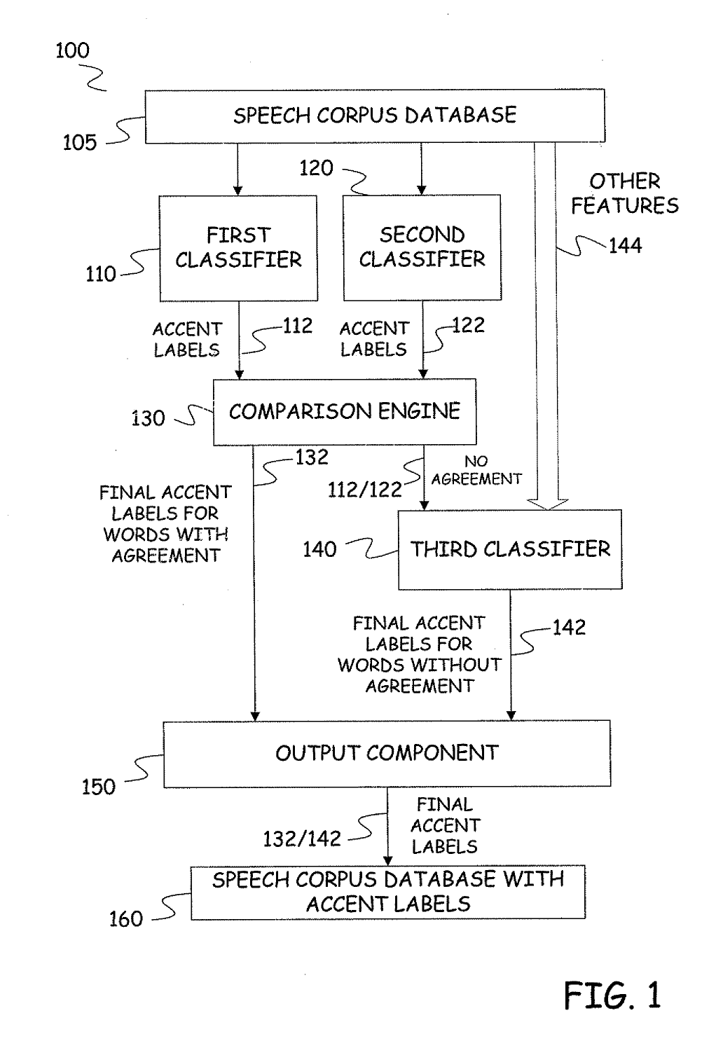

Referring now to FIG. 1, shown is an accent detection system 100 in accordance with a first disclosed embodiment. Accent detection system 100 is provided as an example embodiment, and those of skill in the art will recognize that the disclosed concepts are not limited to the embodiment provided in FIG. 1. Accent detection system 100 is used to automatically label accent in a large speech corpus represented by speech corpus database 105. Automatically labeling accent in the data of speech corpus database 105 provides the potential for a much less time consuming, and therefore less expensive, accent labeling process. The accent labeled speech corpus (represented at 160) can then be used in text-to-speech (TTS) systems for improved speech synthesis.

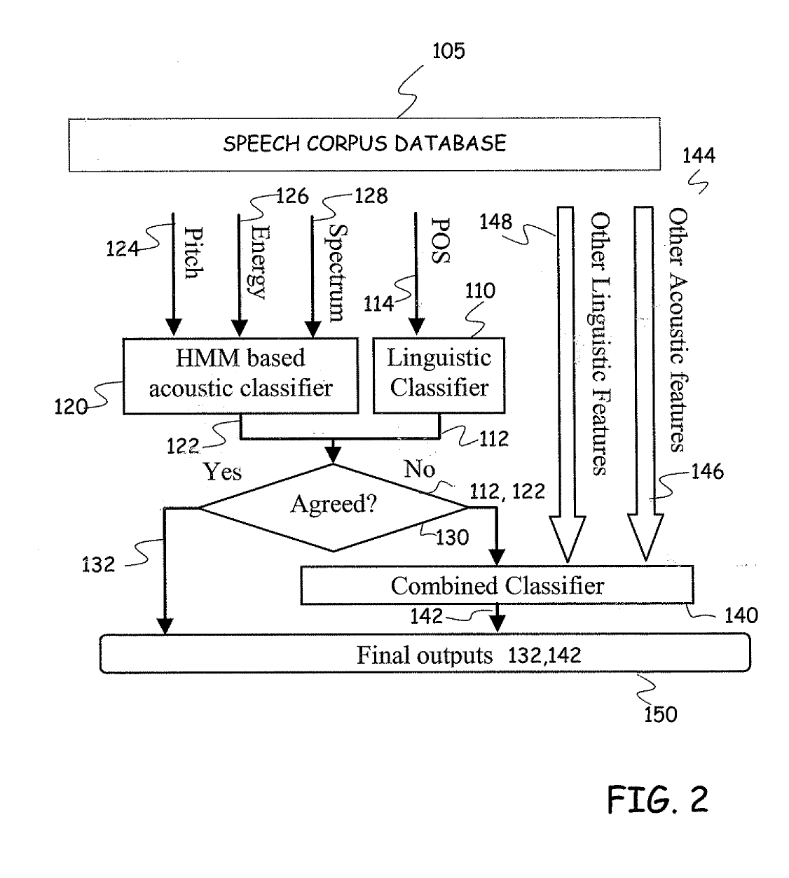

FIG. 1 represents a general embodiment of accent detection system 100, while FIG. 2 which is described below represents one more particular embodiment of accent detection system 100. Disclosed embodiments are not limited, however, to either of the embodiments shown in FIGS. 1 and 2. FIGS. 1 and 2 are described together for illustrative purposes. In FIG. 1, accent detection system 100 is shown to include first and second classifiers 110 and 120, respectively. FIG. 2 illustrates an embodiment in which first classifier 110 is a linguistic classifier, while second classifier 120 is an acoustic classifier.

First classifier 110 is configured to analyze words in the speech corpus 105 and to automatically label accent of the analyzed words based on first criteria. For example, when first classifier 110 is a linguistic classifier as shown in FIG. 2, the first criteria can be part-of-speech (POS) tags 114, where content words are deemed as accented, while non-content or function words are deemed as unaccented. First classifier 110 provides as an output first accent labels 112 of the analyzed words.

Second classifier 120 is also configured to analyze words in the speech corpus database 105 in order to automatically label accent of the analyzed words based on second criteria. For example, when the second classifier 120 is a hidden Markov model (SEMM) based acoustic classifier as illustrated in FIG. 2, the second criteria can include information such as pitch parameters 124, energy parameters 126 and/or spectrum parameters 128. HMM based acoustic classifier criteria are described below in greater detail. After automatically labeling accent, second classifier 120 provides as an output second accent labels 122 of the analyzed words.

System 100 also includes a comparison engine or component which is configured to compare the first accent labels 112 provided by the first classifier and the second accent labels 122 provided by the second classifier to determine if there is agreement between the first classifier 10 and the second classifier 120 on accent labels for particular words. For any words having first and second accent labels 112, 122 which indicate agreement by the first and second classifiers, the comparison engine 130 provides the agreed upon accent labels 112, 122 as final accent labels 132 for those words. For any words that have first and second labels 112, 122 which are not in agreement, a third classifier 140 is included to analyze these words.

Third classifier 140 is, in some embodiments, a combined classifier which includes both linguistic and acoustic classifier aspects or functionality. For words in the speech corpus where the comparison engine 130 determines that there is not agreement between the first and second classifiers, third classifier 140 is configured to provide the final accent labels 142 for those words. Final accent labels 142 are provided, in some embodiments, as a function of the first accent labels 112 for those words provided by the first classifier and the second accent labels 122 for those words provided by the second classifier. Final accent labels 142 can also be provided based on other features 144 from speech corpus database 105. Additional features 144 include in some embodiments other acoustic features 146 and/or other linguistic features 148. In some embodiments, combined classifier 140 is trained using only the limited amount of manually labeled accent data, but this need not be the case in all embodiments. Further discussion of these aspects is provided below.

In some embodiments, system 100 includes an output component or module 150 which provides as an output the final accent labels 132 from comparison engine 130 for words in which there was accent label agreement, and final accent labels 142 from third classifier 140 for the remaining words. As illustrated in FIG. 1, output component 150 can provide these final accent labels to a speech corpus database 160 for storage and later use in TTS applications. Database 160 can be a separate database from database 105, or it can be an updated version of database 105, complete with automatically labeled accents.

Referring specifically to the embodiment illustrated in FIG. 2, the HMM-based acoustic classifier 120 exploits the segmental information of accented vowels in speech corpus database 105. The linguistic classifier 110 captures the text level information. The combined classifier 140 bridges the mismatch between acoustic classifier 120 and linguistic classifier 110, with more accent related information 144 like word N-gram scores, segmental duration and fundamental frequency differences among succeeding segments. The three classifiers are described further below in accordance with exemplary embodiments.

Referring to linguistic classifier 110, usually content words which carry more semantic weight in a sentence are accented while function words are unaccented. Classifier 110 is configured, in exemplary embodiments, to follow this rule. According to their POS tags, content words are deemed as accented while non-content or function words as unaccented.

Referring next to HMM based acoustic classifier 120, in exemplary embodiments this classifier uses the segmental information that can distinguish accented vowels from unaccented ones. To this end, a set of segmental units which are to be modeled was chosen. A first set of segmental units includes accent and position dependent phone sets.

In a conventional speech recognizer, about 40 phones are used in English, and for each vowel a universal HMM is used to model both its accented and unaccented realizations. In disclosed embodiment models, the accented and unaccented are modeled separately as two different phones. Furthermore, to model the syllable structure which includes onset, vowel nucleus and coda, with a higher precision, consonants at the onset position are treated differently from the same phones at the coda position. This accent and position dependent (APD) phone set increases the number of labels from 40 to 78 while the corresponding HMMs can be trained similarly.

Before training the new HMMs, the pronunciation lexicon is adjusted in terms of the APD phone set. Each word pronunciation is encoded into either accented or unaccented versions. In the accented one, the vowel in the primary stressed syllable is accented and all the other vowels unaccented. In the unaccented word, all vowels are unaccented. All consonants at syllable-onset position are replaced with corresponding onset consonant models and similarly for consonants at coda position.

In order to train HMMs for the APD phones, accents in the training data have to be labeled, either manually or automatically. Then, in the training process, the phonetic transcription of the accented version of a word is used if it is accented. Otherwise, the unaccented version is used. Besides the above adjustment, the whole training process can be the same as conventional speech recognition training. API) HMMs can be trained with the standard Baum-Welch algorithm in the HTK software package. The trained acoustic model (classifier 120) is then used to label accents.

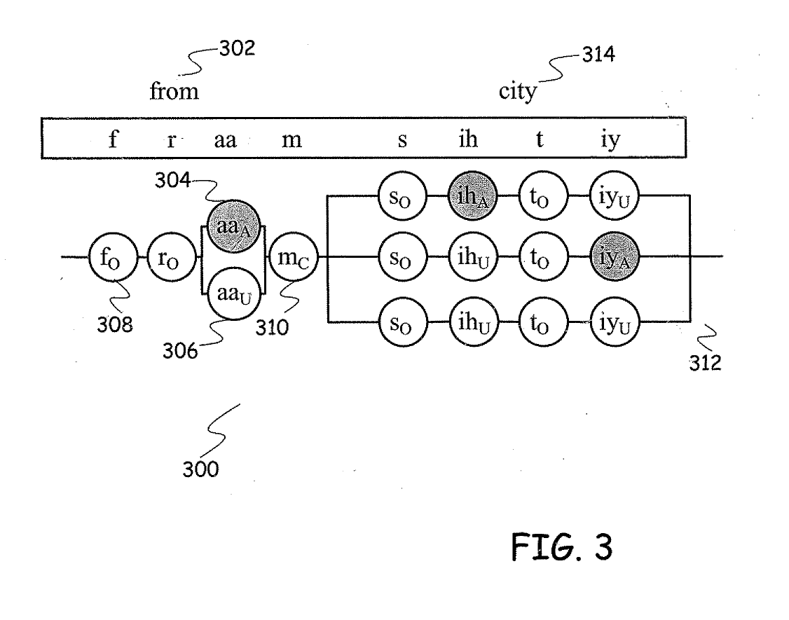

Using APD HMMs in acoustic classifier 120, the accent labeling is actually a decoding in a finite state network 300, an example of which is shown in FIG. 3 where multiple pronunciations are generated for each word in a given utterance. For monosyllabic words (as the ‘from’ shown at 302 in FIG. 3), the vowel has two nodes, A node (stands for the accented vowel) and U node (stands for the unaccented vowel). An example of an “A” node is shown at 304, and an example of a “U” node is shown at 306. In the finite state network 300, each consonant has only one node, either 0 node (stand for an onset consonant) or C node (stand for a coda consonant). An example of an “O” node is shown at 308, and an example of a “C” node is shown at 310. For multi-syllabic words, parallel paths 312 are provided, and each path has at most one A node (as in the word “city” shown at 314 in FIG. 3). After the maximum likelihood search, words aligned with accented vowel are labeled as accented and others as unaccented.

Referring now back to combined classifier 140 shown in FIG. 2, since the linguistic, classifier 110 and the acoustic classifier 120 generate accent labels from different information sources, they do not always agree with each other as noted above and as identified by comparison engine or component 130. To reduce classification errors further, classifier 140 can be constructed by combining the results 112, 122 using an algorithm such as the AdaBoost algorithm, which is well known in the art, with additional accent related, acoustic and linguistic information (shown at 146 and 148, respectively). The AdaBoost algorithm is known in the art for its ability to combine a set of weak rules (e.g., the accent labeling rules of classifiers 110 and 120) to achieve a more precise resulting classifier 140.

Three accent related feature types are used by combined classifier 140. The first type is the likelihood scores of accented and unaccented vowel models and their differences. The second type addresses the prosodic features that cannot be directly modeled by the HMMs, such as the normalized vowel duration and fundamental frequency differences between the current and the neighboring vowels. The third type is the linguistic features beyond POS, like uni-gram, bi-gram and tri-gram scores of a given word because frequently used words tend to be produced with reduced pronunciations. For each type of feature, an individual classifier is trained first. The somewhat weak results provided by these individual classifiers are then combined by classifier 140 into a stronger one. The combining scheme which classifier 140 implements is, in an exemplary embodiment, the well known AdaBoost algorithm.

As noted, the AdaBoost algorithm is often used to adjust the decision boundaries of weak classifiers to minimize classification errors and has resulted in better performance than each of multiple individual ones. The advantage of AdaBoost is that it can combine a sequence of weak classifiers by adjusting the weights of each classifier dynamically according to the errors in the previous learning step. In each boosting step, one additional classifier of a single feature is incorporated.

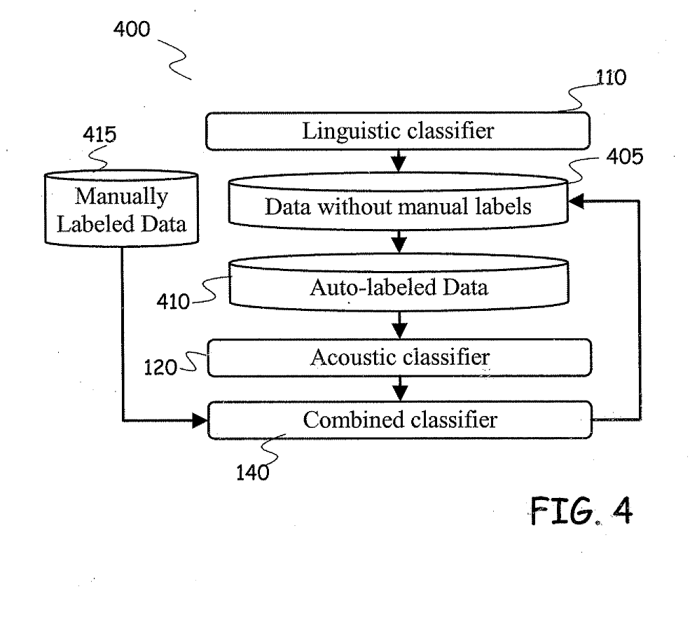

Referring now to FIG. 4, shown is a method 400 of training acoustic classifier 120 in accordance with some embodiments. While FIG. 4 is provided as an example method embodiment, disclosed embodiments are not limited to the specific embodiment shown in FIG. 4. When only a small number of manual labels are available, how to take the best advantage of them becomes important. The method illustrated in FIG. 4 utilizes the unlabeled data 405 which are more abundant than their labeled counterparts 415 to improve the labeling performance. In this method, the linguistic classifier 110 is used to label the data 405 without manual labels to produce auto-labeled data 410. The auto-labeled data is then employed to train the acoustic classifier 120. The combined classifier 140, which combined the output of linguistic classifier 110, acoustic classifier 120 and other features, is used to re-label the speech corpus 405, and new acoustic models 120 are further trained with the additional relabeled data. As noted above, the manual labels 415 are used to train the combined classifier 140.

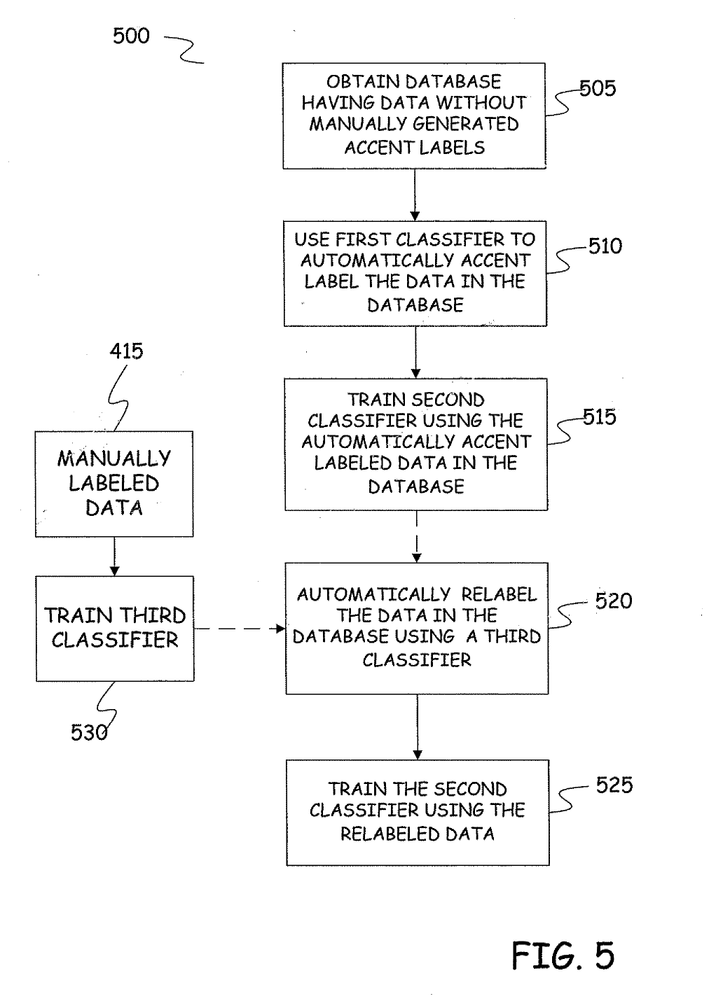

Referring now to FIG. 5, shown is one example of a more general method embodiment 500 for training a classifier when limited manually labeled accent data is available. As shown, embodiments of this method include the step 505 of obtaining a database having data without manually generated accent labels. Then, at step 510, a first classifier 110 is used to automatically accent label the data in the database. Next, a second classifier 120 is trained using the automatically accent labeled data in the database.

In further embodiments, represented as being optional by dashed connecting lines, the method includes the further step 520 of automatically accent relabeling the data in the database using a third classifier 140. Then, at step 525, the second classifier 120 is retrained, or further trained, using the automatically accent relabeled data in the database. Another step, occurring before step 520, can include step 530 of training the third classifier 140 using manually accent labeled data 415.

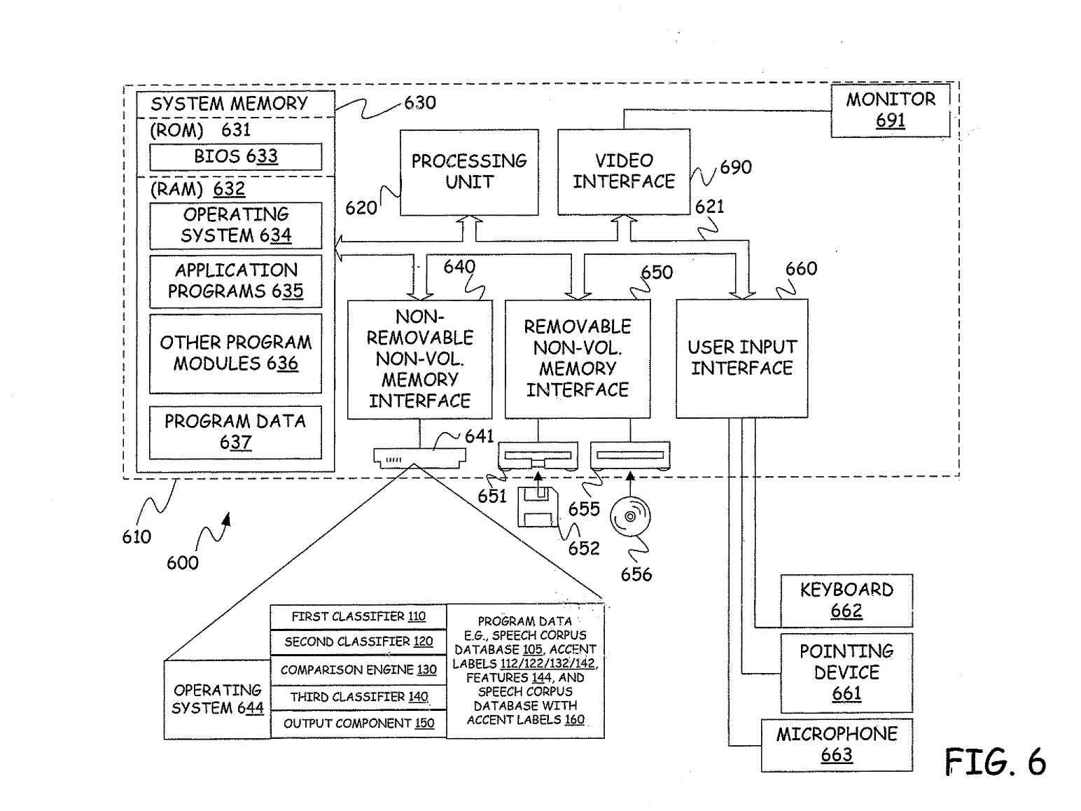

FIG. 6 illustrates an example of a suitable computing system environment 600 on which the concepts herein described may be implemented. In particular, computing system environment 600 can be used to implement components as described above, for example such as first classifier 110, second classifier 120, comparison engine 130, third classifier 140, and output component 150, which are shown stored in a computer-readable medium such as hard disk drive 641. Computing system environment 600 can also be used to store, access and create data such as speech corpus database 105, accent labels 112/122/132/142, features 144, and speech corpus database with accent labels 160 as illustrated in FIG. 6 and discussed above in an exemplary manner. Nevertheless, the computing system environment 600 is again only one example of a suitable computing environment for each of these computers and is not intended to suggest any limitation as to the scope of use or functionality of the description below. Neither should the computing environment 600 be interpreted as having any dependency or requirement relating to any one or combination of components illustrated in the exemplary operating environment 600.

With reference to FIG. 6, an exemplary system includes a general purpose computing device in the form of a computer 610. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a locale bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 600.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

The computer 610 may also include other removable/non-removable volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the computer 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies.

A user may enter commands and information into the computer 610 through input devices such as a keyboard 662, a microphone 663, and a pointing device 661, such as a mouse, trackball or touch pad. Other input devices (not shown) may include a scanner or the like. These and other input devices are often connected to the processing unit 620 through a user input interface 660 that is coupled to the system bus, but may be connected by other interface and bus structures, such as a parallel port or a universal serial bus (USB). A monitor 691 or other type of display device is also connected to the system bus 621 via an interface, such as a video interface 690.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An accent detection system for automatically labeling accent in a large speech corpus, the accent detection system comprising:
a first classifier configured to analyze words in the speech corpus and to automatically label accent of the analyzed words based on first criteria, the first classifier providing as an output first accent labels of the analyzed words;
a second classifier configured to analyze words in the speech corpus and to automatically label accent of the analyzed words based on second criteria, the second classifier providing as an output second accent labels of the analyzed words;
a comparison engine configured to compare the first accent labels provided by the first classifier and the second accent labels provided by the second classifier to determine if there is agreement between the first classifier and the second classifier on accent labels for particular words, for any words having first and second accent labels which indicate agreement by the first and second classifiers, the comparison engine providing the agreed upon accent labels as final accent labels for those words;
a third classifier which is configured to, for words in the speech corpus where the comparison engine determines that there is not agreement between the first and second classifiers, provide the final accent labels for those words as a function of the first accent labels for those words provided by the first classifier and the second accent labels for those words provided by the second classifier; and
an output component which provides as an output of the accent detection system the final accent labels provided by the comparison engine and by the third classifier.

2. The accent detection system of claim 1, wherein the first classifier is a linguistic classifier.

3. The accent detection system of claim 2, wherein the linguistic classifier is configured to automatically label accent of the analyzed words based on part of speech (POS) tags associated with the analyzed words.

4. The accent detection system of claim 1, wherein the second classifier is an acoustic classifier.

5. The accent detection system of claim 4, wherein the second classifier is a hidden Markov model (HMM) based acoustic classifier.

6. The accent detection system of claim 5, wherein the HMM based acoustic classifier is configured to automatically label accent of the analyzed words using an accent and position dependent phone set.

7. The accent detection system of claim 1, wherein the third classifier is a combined classifier that integrates outputs from linguistic and acoustic features of analyzed words.

8. The accent detection system of claim 7, wherein the combined classifier is configured to provide the final accent labels for those words where the comparison engine determines that there is not agreement between the first and second classifiers by combining the first and second accent labels with the use of additional accent related acoustic information and additional accent related linguistic information.

9. A computer-implemented method of training a classifier when limited manually labeled accent data is available, the method comprising:
obtaining a database having data without manually generated accent labels;
using a first classifier to automatically accent label the data in the database; and
training a second classifier using the automatically accent labeled data in the database.

10. The computer-implemented method of claim 9, and further comprising:
automatically accent relabeling the data in the database using a third classifier; and
training the second classifier using the automatically accent relabeled data in the database.

11. The computer-implemented method of claim 9, wherein using the first classifier to automatically accent label the data in the database further comprises using a linguistic classifier to automatically accent label the data in the database.

12. The computer-implemented method of claim 9, wherein training the second classifier using the automatically accent labeled data further comprises training an acoustic classifier using the automatically accent labeled data in the database.

13. The computer-implemented method of claim 12, wherein training the acoustic classifier using the automatically accent labeled data in the database further comprises training the acoustic classifier for accented/unaccented vowels using the automatically accent labeled data in the database.

14. The computer-implemented method of claim 10, and further comprising training the third classifier, prior to accent relabeling the data in the database, using manually accent labeled data.

15. The computer-implemented method of claim 14, wherein automatically accent relabeling the data in the database using the third classifier further comprises automatically accent relabeling the data in the database using a combined classifier for linguistic and acoustic features.

16. The computer-implemented method of claim 10, wherein training the second classifier using the automatically accent relabeled data in the database comprises training a new version of the second classifier using the automatically accent relabeled data in the database.

17. A computer-implemented method of automatically labeling accent in a large speech corpus, the method comprising:
analyzing words in the speech corpus using a first classifier to automatically label accent of the analyzed words based on first criteria and to generate first accent labels for the analyzed words;
analyzing words in the speech corpus using a second classifier to automatically label accent of the analyzed words based on second criteria and to generate second accent labels for the analyzed words;
comparing the first accent labels and the second accent labels to determine if there is agreement between the first classifier and the second classifier on accent labels for particular words, and for any words having first and second accent labels which indicate agreement by the first and second classifiers, providing the agreed upon accent labels as final accent labels for those words;
analyzing words in the speech corpus, for which it was determined that there is not agreement between the first and second classifiers, using a third classifier to provide the final accent labels for those words as a function of the first accent labels for those words provided by the first classifier and the second accent labels for those words provided by the second classifier; and
providing as an output the final accent labels.

18. The computer-implemented method of claim 17, wherein analyzing words in the speech corpus using the first classifier further comprises analyzing words in the speech corpus using a linguistic classifier.

19. The computer-implemented method of claim 17, wherein analyzing words in the speech corpus using the second classifier farther comprises analyzing words in the speech corpus using an acoustic classifier.

20. The computer-implemented method of claim 17, wherein analyzing words in the speech corpus using the third classifier further comprises analyzing words in the speech corpus using a combined classifier that integrates linguistic and acoustic features of analyzed words.
